(19) United States
(12) Patent Application Publication
(10) Pub. No.: US 2013/0082586 A1
(43) Pub. Date: Apr. 4, 2013

(54) ELECTROSTATIC PARTICLE INJECTOR FOR RF PARTICLE ACCELERATORS

(71) Applicant: Oliver Heid, Erlangen (DE)

(72) Inventor: Oliver Heid, Erlangen (DE)

(21) Appl. No.: 13/700,518

(22) PCT Filed: Apr. 4, 2011
(86) PCT No.: PCT/EP11/55202

§ 371 Date: Nov. 28, 2012

(30) Foreign Application Priority Data
May 28, 2010 (DE) 10 2010 021 963.0

(51) Int. Cl. H05H 7/08

(52) U.S. Cl. CPC H05H 7/08
USPC 313/363.1

(57) ABSTRACT

A method and a device for injecting charged particles into the first cavity resonator of an RF particle accelerator are provided. A n electrode is provided at the entrance to the first cavity resonator, which electrode is connected to a DC voltage source and generates a potential well that accelerates the particles leaving an ion source towards the first cavity resonator. As a result of the ion source and the accelerator path, i.e., more particularly the cavity resonators of the accelerator path, lying at a common potential, more particularly earth potential, the electrostatic potential well does not contribute to the overall energy of the particles, the overall acceleration effect is brought about by voltage induction in the RF resonator and the DC voltage source is not loaded by the beam current, and so the latter need not be precisely regulated or powerful.

### CROSS-REFERENCE TO RELATED APPLICATIONS

This application is a U.S. National Stage Application of International Application No. PCT/EP2011/055202 filed Apr. 4, 2011, which designates the United States of America, and claims priority to DE Patent Application No. 10 2010 021 963.0 filed May 28, 2010. The contents of which are hereby incorporated by reference in their entirety.

### TECHNICAL FIELD

The present disclosure relates to a method and to an apparatus for injecting charged particles into a resonator of an RF particle accelerator.

### BACKGROUND

A typical RF particle accelerator has, in essence, an ion source and an accelerator segment comprising a multiplicity of cavity resonators. The charged particles leaving the ion source pass into the first cavity resonator of the accelerator segment and are accelerated from there in the individual resonators in a cascade manner. The “first” cavity resonator is the first cavity resonator as viewed in the beam direction or acceleration direction. The necessary synchronization of the resonators of the accelerator segment or of the RF fields present at the resonators is achieved by an appropriate controller which controls the RF voltage sources generating the RF voltages present at the individual resonators. The cavity resonators are also referred to as RF resonators.

The injection of the particles to be accelerated into the first cavity resonator of the accelerator segment of the RF particle accelerator constitutes a significant complication in the construction of such particle accelerators. The aim here is to inject the charged particles leaving the ion source into the first cavity resonator at a sufficiently high velocity such that the time of flight of the particle through this first cavity resonator is less than half the RF periodic time and thus effective and efficient acceleration can take place.

Owing to the very low velocity of charged particles from typical ion sources, the following measures a) and b) are taken, for example:

a) The ion source is raised to a voltage potential with respect to the accelerator structure, such that the particles are already pre-accelerated up to their entry into the first cavity resonator. However, this solution has only a limited effect because the possible voltage between the ion source and the accelerator structure is very limited owing to the necessary high-voltage insulation of the entire ion source and of the auxiliary instruments (typically in air). Usually the alternative of an accelerator tube at high voltage is not an option. A stable, precisely defined DC high voltage source which is loaded with the beam current is also necessary.

b) The front part of the accelerator as viewed in the beam direction is operated at a lower frequency than the rear part, which takes into consideration the initially lower velocity of the particles. The frequency ratio should be chosen here to be rational and phase-locked. This is associated with a more complex and costlier controller.

### SUMMARY

One embodiment provides an accelerator segment for an RF particle accelerator having at least one cavity resonator, which is configured for accelerating a particle leaving an ion source, wherein electrostatic pre-acceleration owing to a potential well takes place between the ion source and the first cavity resonator of the accelerator segment, and the ion source and the accelerator segment, in particular the first cavity resonator, are at the same potential.

In a further embodiment, an electrode is attached at the first cavity resonator of the accelerator segment, which electrode is at a potential with respect to the ion source, with the result that the accelerating potential well for the particle leaving the ion source is produced. In a further embodiment, the electrode is configured as a ring electrode at the entrance to the first cavity resonator, in particular configured such that it surrounds the entry opening of the first cavity resonator. In a further embodiment, the electrode is separated from the remaining resonator structure of the first cavity resonator by an insulator, e.g., by an annular insulation segment. In a further embodiment, a capacitor is provided which is connected in parallel and configured and arranged so as to suppress a significant AC voltage of the electrode with respect to the remaining resonator structure of the first cavity resonator during operation of the first cavity resonator. In a further embodiment, the electrode is connected to the remaining resonator structure of the first cavity resonator by way of the capacitor. In a further embodiment, the potential well and an RF field applied to the first cavity resonator during operation of the accelerator structure are matched to each other such that a decelerating force prevailing downstream of the entrance to the first cavity resonator as viewed in the particle beam direction owing to the potential well is compensated and exceeded by a simultaneous acceleration force of the RF field acting on the particle. In a further embodiment, the first cavity resonator is situated, as viewed in the particle beam direction, in a region in which the potential well has a decelerating effect on the particle. In a further embodiment, the minimum of the potential well is situated, as viewed in the particle beam direction, at the entrance of the first cavity resonator.

In another embodiment, a method is provided for accelerating a particle leaving an ion source with an RF particle accelerator, having an accelerator segment with at least one cavity resonator, which for its part is configured for accelerating the particle leaving the ion source, wherein the particle is pre-accelerated electrostatically using a potential well and, owing to the attracting action of the potential well on the particle, decelerated again after it has passed the minimum of the potential well.

In a further embodiment, the particle travels through the entire potential well. In a further embodiment, the potential well is produced with an electrode which is brought to a first potential, while at least the ion source and the first cavity resonator are at a second potential, which differs from the first.

### BRIEF DESCRIPTION OF THE DRAWINGS

Example embodiments will be explained in more detail below with reference to figures, in which:

FIG. 1 shows a detail of an RF particle accelerator having an ion source and the first cavity resonator with acceleration electrode, and

FIG. 2 shows the potential profile for a particle leaving the ion source.

### DETAILED DESCRIPTION

Some embodiments provide systems and methods for injecting the particles leaving an ion source of an RF particle accelerator into the first cavity resonator of the accelerator segment of the RF particle accelerator with sufficiently high velocity.

In some embodiments, in the accelerator segment for an RF particle accelerator having at least one cavity resonator, which is configured for accelerating a particle leaving an ion source, electrostatic pre-acceleration owing to a potential well takes place between the ion source and the first cavity resonator of the accelerator segment. Here, the ion source and the accelerator segment, in particular the first cavity resonator, are at the same potential.

An electrode is attached at the first cavity resonator of the accelerator segment, which electrode is at a potential with respect to the ion source, with the result that the accelerating potential well for the particle leaving the ion source is produced.

The electrode is configured as a ring electrode at the entrance to the first cavity resonator, in particular configured such that it surrounds the entry opening of the first cavity resonator. The expression “ring electrode” in this case does not necessarily have to mean that the cross section of the electrode is circular. Other cross sections are also feasible, for example rectangular, elliptical or the like. In principle it should be assumed that the cross section of the electrode is matched to the cross section of the beamline.

The electrode is separated from the remaining resonator structure of the first cavity resonator by an insulator, e.g., by an annular insulation segment. The expression “annular” in this case does not necessarily mean a circular cross section either. Ideally, the shape or the cross section of the insulator is matched to the shape of the electrode.

Alternatively or additionally, a capacitor is provided which is connected in parallel and configured and arranged so as to suppress a significant AC voltage of the electrode with respect to the remaining resonator structure of the first cavity resonator during operation of the first cavity resonator.

The electrode is connected to the remaining resonator structure of the first cavity resonator by way of this capacitor.

The potential well and an RF field applied to the first cavity resonator during operation of the accelerator structure are matched to each other such that a decelerating force prevailing downstream of the entrance to the first cavity resonator as viewed in the particle beam direction owing to the potential well is compensated and exceeded by a simultaneous acceleration force of the RF field acting on the particle.

The first cavity resonator is situated, as viewed in the particle beam direction, substantially in a region in which the potential well has a decelerating effect on the particle.

The minimum of the potential well is situated, as viewed in the particle beam direction, at the entrance of the first cavity resonator.

In the disclosed method for accelerating a particle leaving an ion source with an RF particle accelerator, having an accelerator segment with at least one cavity resonator, which for its part is configured for accelerating the particle leaving the ion source, the particle is pre-accelerated electrostatically using a potential well and, owing to the attracting action of the potential well on the particle, decelerated again after it has passed the minimum of the potential well.

The particle travels through the entire potential well, i.e. up and down.

The potential well is produced with an electrode which is brought to a first potential U1, while at least the ion source and the first cavity resonator are at a second potential U0, which differs from the first.

The disclosure thus proposes the use of electrostatic pre-acceleration from the ion source to the first cavity resonator of the accelerator segment by way of a potential well. In order to produce the electrostatic pre-acceleration, a DC voltage is produced between the ion source and the first cavity resonator by applying a DC voltage potential to an additional electrode, for example at the entrance to the cavity resonator.

The arrangement disclosed herein thus constitutes a DC voltage potential well having a potential minimum at the resonator entrance of the first cavity resonator, which potential well accelerates the particle away from the ion source and allows it to enter the resonator at an initial velocity.

In some embodiments, both the ion source and the accelerator structure are at the same potential in this case, e.g., at ground potential. In the absence of the RF field used for the typical accelerator operation in the resonator, the particle velocity on passing through the resonator would thus be decelerated again to the original, low velocity of the particles when leaving the ion source, because the exit opening of the resonator has the same potential as the source and because the particles pass through the entire potential well. In summary, this means that:

a) the electrostatic potential well does not contribute to the overall energy of the particles,

b) the overall acceleration effect is brought about by voltage induction in the RF resonator,

c) the DC voltage source is not loaded with the beam current such that it need not be precisely regulated nor powerful.

Certain embodiments advantageously make available a DC voltage potential well, which is passed through entirely, i.e. downwardly and upwardly, owing to the common potential of the ion source and of the accelerator structure, in particular of the first cavity resonator. In addition, in some embodiments an RF resonator is situated in the region of the decelerating field region. In typical injectors, by contrast, in which a difference voltage is present between ion source and accelerator structure or resonator, as mentioned in the introduction, the potential is only passed through in the downward direction.

The RF field applied to the first cavity resonator expediently has, during the accelerating phase, a sufficient intensity to compensate and exceed the decelerating force of the DC voltage field by simultaneous acceleration force in the RF field, such that the particle can leave the first cavity resonator at a specific velocity.

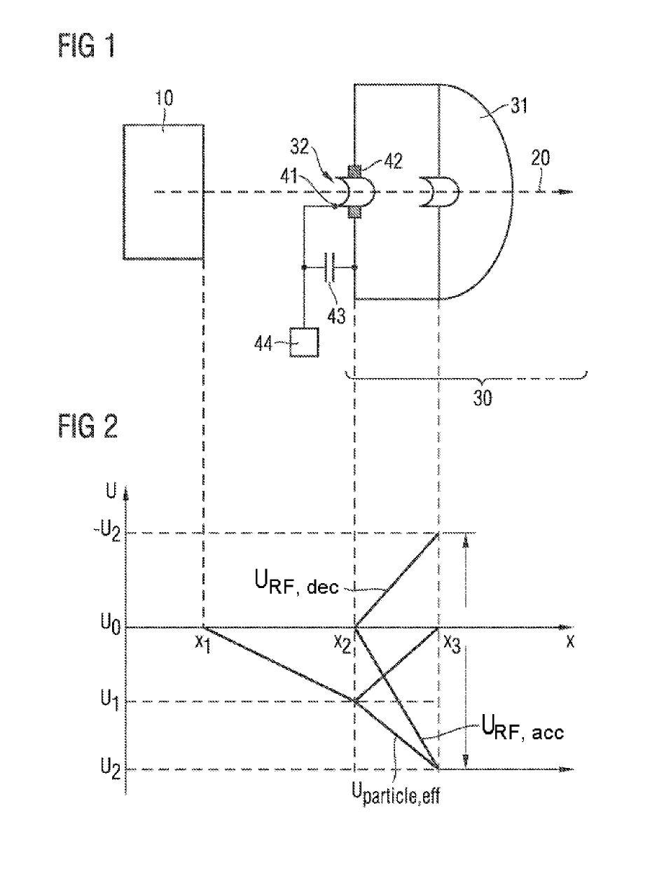

FIG. 1 shows an RF particle accelerator 1 having an ion source 10 and a particle beam 20 emerging from the ion source 10. An accelerator segment 30, which typically has a plurality of cavity resonators, is arranged downstream of the ion source 10 in the acceleration direction, that is to say from left to right in FIG. 1. FIG. 1, however, only shows the first cavity resonator 31 of the accelerator segment 30 in a sectional illustration. The design of the further cavity resonators does not differ from that of the cavity resonators in commercially available RF accelerators.

An electrode 41, which is configured as a ring electrode and surrounds the entry opening 32 of the first cavity resonator 31, is attached at the front face, as viewed in the beam direction, of the first cavity resonator 31. The ring electrode 41 is separated from the remaining resonator structure of the first cavity resonator 31 by an insulator 42, which is ideally likewise of annular configuration. The “remaining resonator structure” of the first cavity resonator 31 means all the components of the first cavity resonator 31 aside from the electrode 41 and the insulation 42. Said insulation ring 42 suppresses a significant AC voltage of the ring electrode 41 with respect to the remaining resonator structure of the first cavity resonator 31 during operation of the resonator 31. Such a significant AC voltage can be caused for example by capacitive coupling to the RF field in the resonator.

The ion source 10 and the remaining accelerator structure, in particular the cavity resonators of the accelerator segment 30, are at the same potential. By way of example, these components can be grounded.

Additionally or alternatively to this insulation ring 42, a capacitor 43, which is connected in parallel and via which the electrode 41 is connected to the remaining resonator structure of the first cavity resonator 31, can be used for the same purpose. A DC voltage source 44, which raises the electrode 41 to the required potential, is also provided.

While the electrode 41 is brought to a specific potential U1 (see FIG. 2) by the DC voltage source 44, the rest of the arrangement is at a potential U0. U1 and U0 are chosen here such that the particles leaving the ion source 10 are accelerated in the direction of the ring electrode 41. The arrangement thus constitutes a DC voltage potential well having a potential minimum at the resonator entrance. The particles leaving the ion source 10 are accelerated away from the source 10 and enter the resonator 31 at an initial velocity.

As explained above, with the exception of the electrode 41, the ion source 10 and the accelerator segment 30 are at the same potential U0. This ultimately has the result that, in the absence of the RF field that is applied to the RF resonator 31 and to the remaining resonators (not illustrated) of the accelerator segment 30 during normal accelerator operation, the particle velocity that was achieved by the pre-acceleration owing to the ring electrode 41 is reduced after passage through the resonator 31 back to that initial low velocity that the particles have upon exiting the ion source 10, because the exit opening of the resonator 31 has the same potential as the ion source 10. The electrostatic potential well, which brings about the pre-acceleration of the particles leaving the ion source 10, thus does not contribute to the overall energy of the particles.

FIG. 2 shows the potential profile for a particle leaving the ion source 10, with the dashed curve representing the potential well owing to the electrode 41. As mentioned above, the ion source and the accelerator structure or the accelerator segment 30 are at a common potential U0. This is the potential with which the particles leave the ion source 10 at the location x1. The first cavity resonator 31 extends, as viewed in the longitudinal direction, from location x2 to location x3. Owing to the potential U1 present at the ring electrode 41, a potential well results for the particles leaving the ion source 10, which potential well has an accelerating action on the particles and has a minimum at location x2. In other words, the particles undergo an acceleration between the location x1 and the location x2. Since the first cavity resonator 31, except for the electrode 41, is at the potential U0, the particles passing through the ring electrode 41 are subsequently decelerated.

Expediently, the RF field present at the first cavity resonator 31 has, during the accelerating phase, i.e. when the electrical field forming in the RF resonator 31 has an orientation in the beam direction, a sufficient intensity for compensating and exceeding the decelerating force of the potential well in the region between x2 and x3 by a simultaneous acceleration force of the RF field, with the result that the particle can leave the first cavity resonator at a specific velocity. The potentials U0, U1 and the RF field are matched to one another such that in the accelerating phase of the RF resonator, the acceleration force effected by the RF field is greater than the decelerating force produced by the potential well.

The particle velocity at the exit of the first cavity resonator 31 thus results ultimately only from the RF field present at the cavity resonator, without the ring electrode 41 and the potential U1 present at the ring electrode 41 having any influence.

FIG. 2 illustrates the situation in the accelerating phase of the RF field. Here, the corresponding RF AC voltage U_{RF} has an amplitude U2. Illustrated is the potential profile of the RF AC voltage U_{RF} both in the decelerating phase (U_{RF,dec}) and in the accelerating phase (U_{RF,acc}). The curve designated U_{particle,eff} indicates the potential, effective in the accelerating phase, of the particles to be accelerated, synonymous with their kinetic energy.

What is claimed is:

1. An accelerator segment for an RF particle accelerator having at least one cavity resonator, which is configured for accelerating a particle leaving an ion source:
wherein the an source and a first cavity resonator of the accelerator segment are arranged such that:
electrostatic pre-acceleration caused by a potential well occurs between the ion source and the first cavity resonator of the accelerator segment, and
the ion source and the first cavity resonator of the accelerator segment are maintained at the same potential.

2. The accelerator segment of claim 1, comprising an electrode coupled to the first cavity resonator of the accelerator segment, the electrode having a potential with respect to the ion source that produces the accelerating potential well for the particle leaving the ion source.

3. The accelerator segment of claim 2, wherein the electrode is configured as a ring electrode at the entrance to the first cavity resonator.

4. The accelerator segment of claim 2, wherein the electrode is separated from the remaining resonator structure of the first cavity resonator by an insulator.

5. The accelerator structure of claim 2, comprising a capacitor connected in parallel and configured and arranged to suppress a significant AC voltage of the electrode with respect to the remaining resonator structure of the first cavity resonator during operation of the first cavity resonator.

6. The accelerator structure of claim 5, wherein the electrode is connected to the remaining resonator structure of the first cavity resonator via the capacitor.

7. The accelerator structure of claim 1, wherein the potential well and an RF field applied to the first cavity resonator during operation of the accelerator structure are matched to each other such that a decelerating force prevailing downstream of the entrance to the first cavity resonator, as viewed in the particle beam direction owing to the potential well, is compensated and exceeded by a simultaneous acceleration force of the RF field acting on the particle.

8. The accelerator structure of claim 1, wherein the first cavity resonator is situated, as viewed in the particle beam direction, in a region in which the potential well has a decelerating effect on the particle.

9. The accelerator structure of claim 1, wherein a minimum of the potential well is situated, as viewed in the particle beam direction, at the entrance of the first cavity resonator.

10. A method for accelerating a particle leaving an ion source with an RF particle accelerator, having an accelerator segment with at least one cavity resonator configured for accelerating the particle leaving the ion source comprising:
pre-accelerating the particle electrostatically using a potential well, and
due to an attracting action of the potential well on the particle, decelerating the particle after it has passed a minimum of the potential well.

11. The method of claim 10, wherein the particle travels through the entire potential well.

12. The method of 10, wherein the potential well is produced with an electrode which is brought to a first potential, while at least the ion source and the first cavity resonator are at a second potential, which differs from the first.

13. The accelerator segment of claim 3, wherein the ring electrode surrounds the entry opening of the first cavity resonator.

14. The accelerator segment of claim 4, wherein the insulator comprises an annular insulation segment.
